(19) United States
(12) Patent Application Publication
(10) Pub. No.: US 2014/0156627 A1
(43) Pub. Date: Jun. 5, 2014

(54) MAPPING OF TOPIC SUMMARIES TO SEARCH RESULTS

(71) Applicant: MICROSOFT CORPORATION, Redmond, WA (US)

(72) Inventors: Micol Marchetti-Bowick, Pittsburgh, PA (US); Franco Salvetti, San Francisco, CA (US); Justin John Trobec, Fremont, CA (US); Samuel Mandell, Mountain View, CA (US); Gianluca Donato, Los Altos, CA (US); David D. Ahn, San Francisco, CA (US)

(73) Assignee: MICROSOFT CORPORATION, Redmond, WA (US)

(21) Appl. No.: 13/691,713

(22) Filed: Nov. 30, 2012

(51) Int. Cl. G06F 17/30

(52) U.S. Cl. CPC G06F 17/30864
USPC 707/709

(57) ABSTRACT

Architecture that facilitates the mapping of multimedia topic summaries from one data source, to web search results from another data source. An algorithmic technique is provided that discriminates (selects) between topic summaries that are wanted and not wanted for presentation to the search engine user based on a predetermine set of characteristics or features. Topic summaries are each pre-associated with a topic identifier. A page identifier is extracted from or created for the webpage that is used to match the topic identifiers to the correct webpage. The page identifier is aligned with the topic identifier of the topic summaries to find matches between topic summaries and webpages. Once alignment is completed, the correct topic identifier is inserted into the internal extended representation (e.g., associated with the content header) of every webpage, which enables the subsequent fetch of the topic summaries for display to users.

### BACKGROUND

The enormous amount of data available for searching continues to increase unabated, thereby making the prospect of finding the desired information a daunting process. Moreover, the data is dispersed over many different websites and other data sources. In web search, multimedia content is increasingly becoming more desirable than simply textural content. Accordingly, a heretofore desirable and unrealized feature is the ability to attach content from one data source to standard web results of another source. However, at least two challenges associated with this goal are unrealized: the mapping of pieces of the outside content to the correct web results, and selecting only high-quality content to display along with the web result.

### SUMMARY

The following presents a simplified summary in order to provide a basic understanding of some novel embodiments described herein. This summary is not an extensive overview, and it is not intended to identify key/critical elements or to delineate the scope thereof. Its sole purpose is to present some concepts in a simplified form as a prelude to the more detailed description that is presented later.

The disclosed architecture facilitates the mapping of topic summaries (e.g., multimedia) from one data source, to search results from another data source. In addition, the architecture provides an algorithmic technique for discriminating (selecting) between topic summaries that will and will not be presented to the search engine user based on a predetermine set of characteristics (or features).

To facilitate the mapping of topic summaries to search results, the topic summaries are each pre-associated with a topic identifier (ID), either or both of which can be generated by the data provider (website). A page ID is associated with (e.g., extracted from, created for) the webpage and mapped to the topic ID to match the topic ID to the correct webpage. The page ID is then mapped to the topic ID of the associated topic summary to find matches between topic summaries and webpages. Once the mapping is completed, the correct topic ID is ingested into the internal (extended) representation (information) (e.g., content header) of the webpage (and every related webpage) to enable the subsequent fetch of the topic summaries for display in search results to a user. In other words, the topic ID is part of metadata added to the internal extended representation of the web document.

With respect to the selection of topic summaries that are to be or not to be displayed, a first step in building such a discrimination algorithm that can distinguish between these summaries is to select a random subset of all topic summaries and then obtain human judgments that label each summary as wanted or unwanted for display. Thereafter, a series of manually chosen features are extracted from both the text and video elements of the multimedia presentation. Using these features, the labeled summary examples are used to train an automated classifier. The trained classifier is then run on the remainder of the data, which produces a list of all wanted topic summaries.

To the accomplishment of the foregoing and related ends, certain illustrative aspects are described herein in connection with the following description and the annexed drawings. These aspects are indicative of the various ways in which the principles disclosed herein can be practiced and all aspects and equivalents thereof are intended to be within the scope of the claimed subject matter. Other advantages and novel features will become apparent from the following detailed description when considered in conjunction with the drawings.

### BRIEF DESCRIPTION OF THE DRAWINGS

FIG. 1 illustrates a system in accordance with the disclosed architecture.

FIG. 2 illustrates an alternative system that includes a selection algorithm for selecting topic summaries to present.

FIG. 3 illustrates a system of mappings between desired entities.

FIG. 4 illustrates a method in accordance with the disclosed architecture.

FIG. 5 illustrates an alternative method in accordance with the disclosed architecture.

FIG. 6 illustrated a block diagram of a computing system that maps topic summaries to search results in accordance with the disclosed architecture.

### DETAILED DESCRIPTION

The disclosed architecture facilitates the mapping and selection of topic summaries (e.g., textual, multimedia) from one data source, to web search results from another data source using a topic summary (topic) identifier inserted into webpages. Selection between topic summaries that are to be displayed with the search result and not to be displayed to the search engine user is based on a predetermine set of characteristics or features. An algorithmic technique is disclosed that discriminated between the topic summaries for or not for presentation.

The topic summaries are each pre-associated with a topic identifier (ID), which can be generated by the data provider (website owner). In order to match the topic IDs to the correct webpage, a webpage ID is utilized. The webpage ID can be created based on the URL (uniform resource locator), for example. The webpage ID is aligned with the topic ID of the topic summaries to find matches between topic summaries and webpages. By inserting the correct topic ID as metadata into the internal extended representation of every webpage, the topic summaries can be retrieved and displayed to users as part of the search result(s).

A selection algorithm distinguishes between to-be displayed summaries and not-to-be displayed topic summaries based on a training and random subset of all topic summaries and human judgments that label the summaries one as “good” or “bad”. Thereafter, a set of manually chosen features are extracted from both the text and video elements of the multimedia presentation, and the labeled examples are used to train an automated classifier. The trained classifier is runs on the remainder of the data, which produces a list of all to-be displayed topic summaries.

Mapping is post-crawling process, while insertion into the internal extended web document representation occurs at crawl time. More specifically, the URL serves the topic summary, and at re-crawling, the mapping is injected back into webpage document. At runtime, when webpage (document) is served, the topic ID is accessed to align with the topic summary.

Multiple webpages can link to same topic summary. The topic summary can be multimedia decoration of a search result. Additionally, the topic summary can have multiple topic IDs. The topic summary can be generated by using different data sources, features, and media. The topic summary can be aligned with different webpages, which are related to the query. Only the selected alignment gets decorated with the topic summary. The topic summary can be built with some of the content of the webpages or not any of the webpage content.

Reference is now made to the drawings, wherein like reference numerals are used to refer to like elements throughout. In the following description, for purposes of explanation, numerous specific details are set forth in order to provide a thorough understanding thereof. It may be evident, however, that the novel embodiments can be practiced without these specific details. In other instances, well known structures and devices are shown in block diagram form in order to facilitate a description thereof. The intention is to cover all modifications, equivalents, and alternatives falling within the spirit and scope of the claimed subject matter.

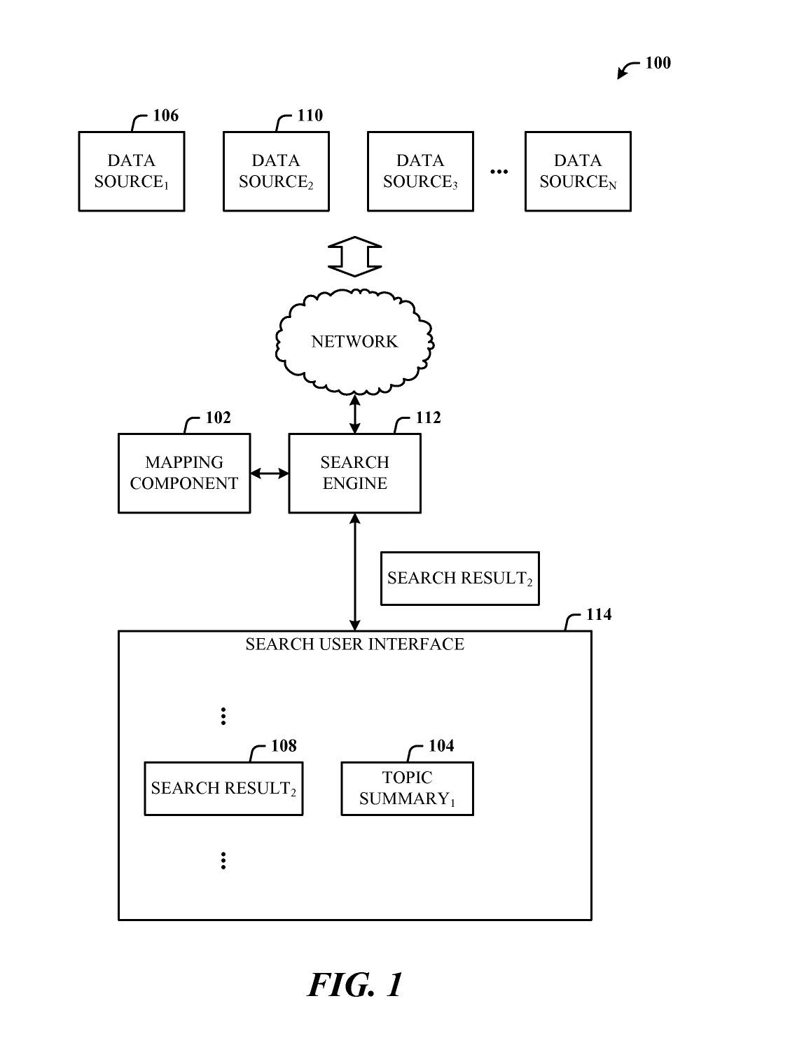

FIG. 1 illustrates a system 100 in accordance with the disclosed architecture. The system 100 can include a mapping component 102 that performs a mapping that facilitates presentation of a topic summary 104 of a first data source 106 in association with a search result 108 related to a webpage of a second data source 110. The mapping component 102 can be implemented separately or as part of a search engine 112 which processes a user query to return the search result 108 in a user interface 114.

The topic summary 104 has a topic identifier that is mapped to a page identifier of the webpage (of the second data source 110). The topic summary 104 is fetched for display in the user interface 114 as part of the search result 108 related to the second data source 110 based on the page identifier. As will be described herein, the topic identifier is inserted as metadata into an internal extended representation of the webpage (of the second data source 110). Specifically, the topic ID metadata can be inserted into the internal extended representation associated with the content header. The topic identifier can be mapped to multiple webpages. The webpage identifier can be created or be a predefined identifier that is obtained from the webpage.

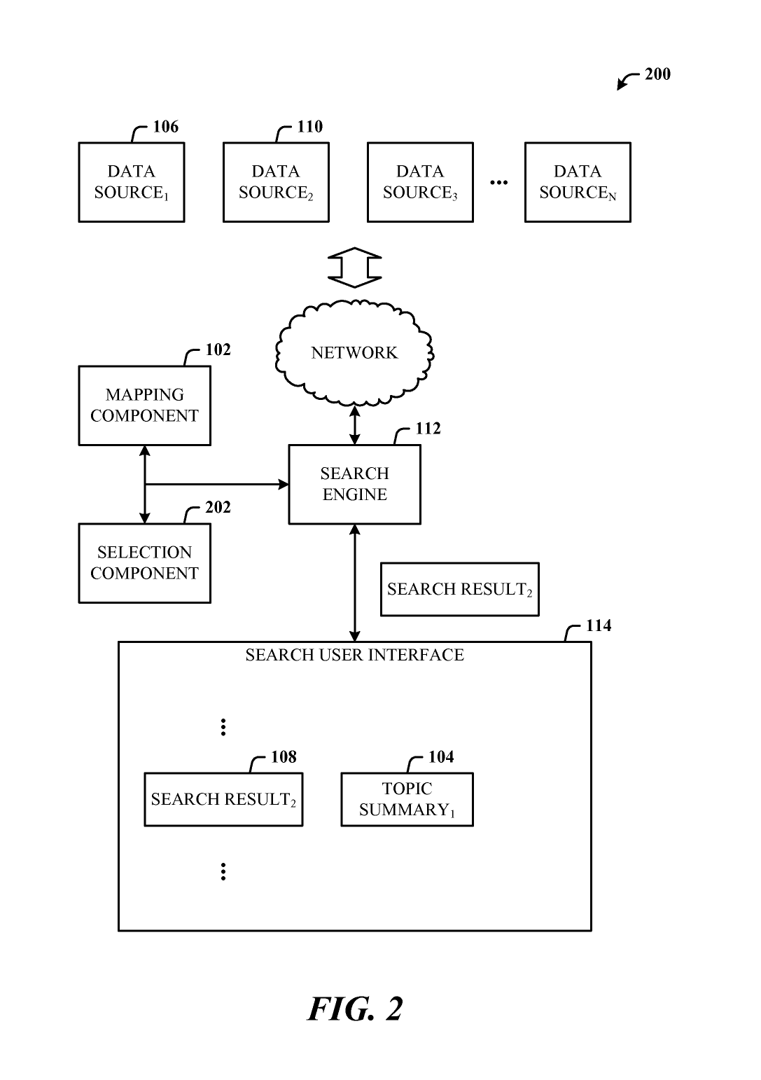

FIG. 2 illustrates an alternative system 200 that includes a selection algorithm for selecting topic summaries to present. System 200 includes the entities and components of system 100 of FIG. 1 and a selection component 202 that includes the selection algorithm which selects the topic summary 104 for presentation as part of the search result 108. The selection component 202 discriminates, from a set of topic summaries, which topic summaries to display and which topic summaries to not display as part of the search result 108. The selection component 202 includes a classifier that selects the topic summaries using a selection model that is trained based on topic summaries tagged as for display or not for display. The topic summaries are classified using the classifier based on features related to text and media elements of the topic summaries.

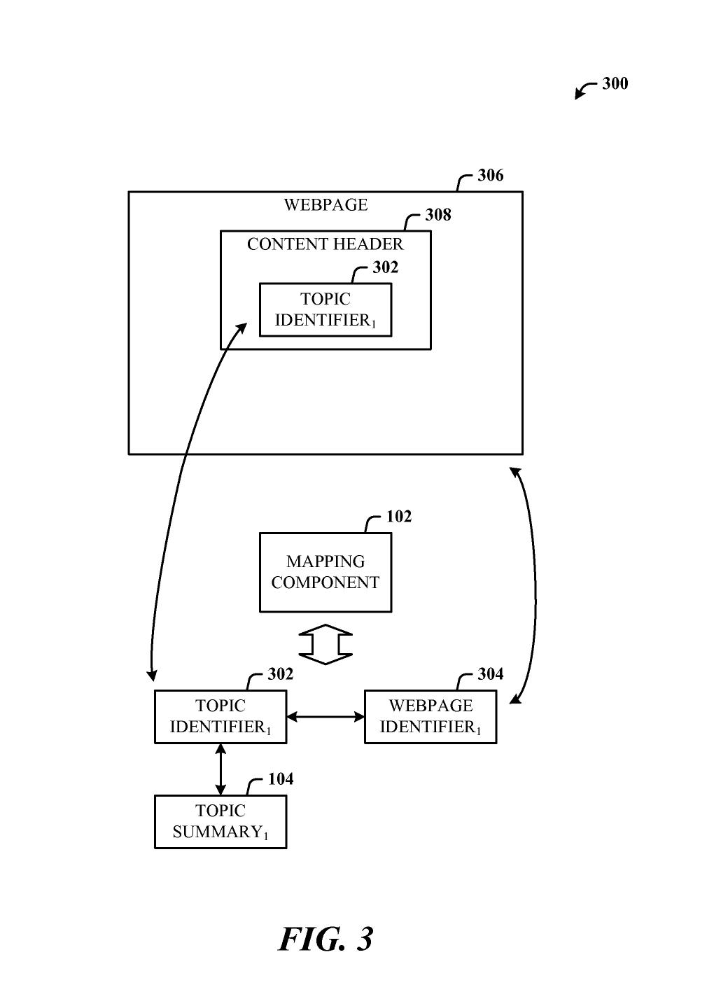

FIG. 3 illustrates a system 300 of mappings between desired entities. The topic summary 104 has a topic identifier 302. The mapping component 102 performs a mapping of the topic identifier 302 to a webpage identifier 304 of a webpage 306 (of the second data source 110). The mapping component 102 can create the webpage identifier 304 based on external information, or obtain the webpage identifier 304 based on information (e.g., json (Javascript™ object notation) data) from the webpage. The topic summary 104 is retrieved as part of the search result 108 based on the webpage identifier 304. As shown, the topic identifier 302 can be inserted into internal extended representation of the (e.g., content header 308) of the webpage 306. The topic identifier 302 can be mapped to multiple webpages.

Included herein is a set of flow charts representative of exemplary methodologies for performing novel aspects of the disclosed architecture. While, for purposes of simplicity of explanation, the one or more methodologies shown herein, for example, in the form of a flow chart or flow diagram, are shown and described as a series of acts, it is to be understood and appreciated that the methodologies are not limited by the order of acts, as some acts may, in accordance therewith, occur in a different order and/or concurrently with other acts from that shown and described herein. For example, those skilled in the art will understand and appreciate that a methodology could alternatively be represented as a series of interrelated states or events, such as in a state diagram. Moreover, not all acts illustrated in a methodology may be required for a novel implementation.

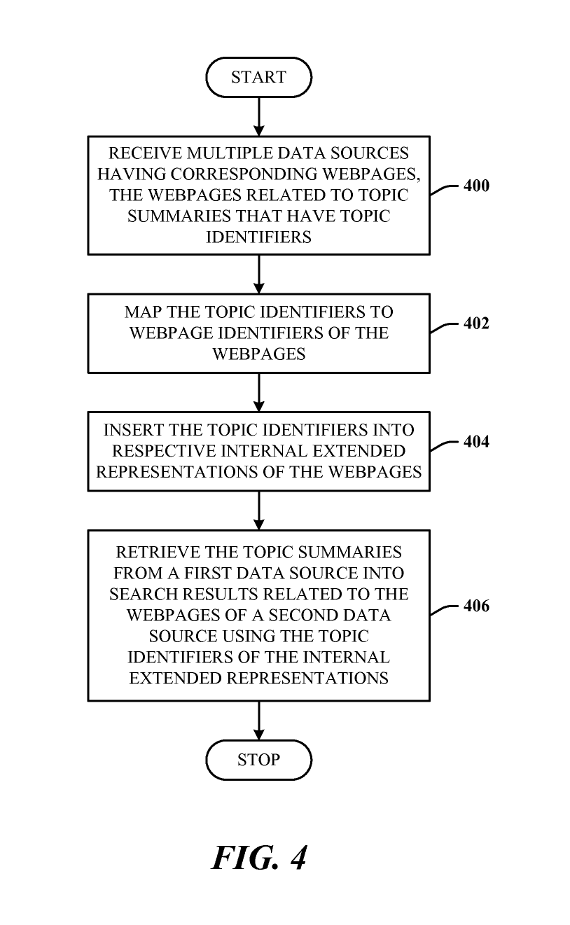

FIG. 4 illustrates a method in accordance with the disclosed architecture. At 400, multiple data sources are received (exist) having corresponding webpages. The data sources can includes websites on the Internet and sites on intranets, for example. The webpages are related to topic summaries that have topic identifiers. At 402, the topic identifiers are mapped to webpage identifiers of the webpages. At 404, the topic identifiers are inserted into respective internal extended representations of the webpages. At 406, the topic summaries are retrieved from a first data source into search results related to the webpages of a second data source using the topic identifiers of the internal extended representations. This can be accomplished via a search engine.

The method can further comprise creating the webpage identifier based on information from the webpage or external information. The method can further comprise presenting a topic summary proximate a related search result. The topic summary can be presented to the right, left, above, or below the search result, based on the user interface space available for presentation. The method can further comprise classifying the topic summaries as to-be displayed (wanted) or not-to-be displayed (unwanted) based on features related to text and media elements of the topic summaries. The method can further comprise mapping the topic summaries to multiple webpages. The method can further comprise serving the topic summary at runtime based on the inserted topic identifier of the internal extended representation.

Following is a description of features that can be utilized to classify topic summaries as wanted or unwanted. This is not an exhaustive list, as other features can be utilized as desired.

Generally, the length of time (e.g., in seconds) to process can be a feature. Features related to text can include types-to-token ratio (which measures richness of the vocabulary of the textual part of the topic summary), length in characters, length in tokens, punctuation density, average word length, suffix/prefix (e.g., -ing), name density as determined via a name tagger, number of commas, PoS (part of speech tags, e.g., verb, base form-VB; adjective-JJ) ratios (e.g., #VB/#JJ) as defined according to a Penn Treebank form or Brown Corpus tags, for example, and so on.

With respect to images, features can include the number of images, mean/variance resolution, mean/variance size, mean/variance colors, average pairwise image similarity coefficient, time before first image, and so on. With respect to videos, the features can include mean/variance length, total number, video source (e.g., website), the number of detectable scene changes, tiem before the first video, and so on. With respect to infographics (no images, no video, but data visualization that include maps) (e.g., height of a mountain), the features can include number, time before first infographics, types (e.g., [age, height, length]→[1, 0, 1])—a binary feature, and so on. With respect to audio (e.g., external narration in voiceover), the features can include yes/no, and so on.

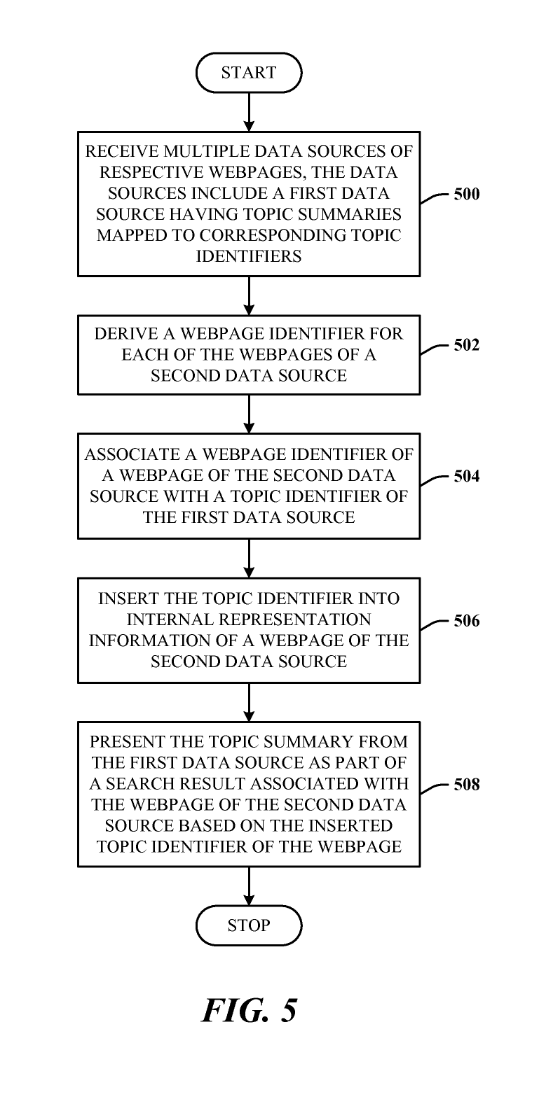

FIG. 5 illustrates an alternative method in accordance with the disclosed architecture. At 500, the multiple data sources of respective webpages are received as before. The data sources include a first data source having topic summaries mapped to corresponding topic identifiers. At 502, a webpage identifier is derived for each of the webpages of a second data source. At 504, a webpage identifier of a webpage of the second data source is associated with a topic identifier of the first data source. At 506, the topic identifier is inserted into internal representation information of the webpage of the second data source. At 508, the topic summary from the first data source is presented as part of a search result associated with the webpage of the second data source based on the inserted topic identifier of the webpage.

The method can further comprise classifying the topic summaries as to-be displayed or not-to-be displayed based on features related to text and media elements of the topic summaries. The method can further comprise presenting the topic summary as an interactive object proximate the search result. The method can further comprise deriving the webpage identifier by either creating the webpage identifier for the webpage or obtaining the webpage identifier from the webpage. The method can further comprise serving the topic summary at runtime based on the inserted topic identifier of the webpage.

As used in this application, the terms “component” and “system” are intended to refer to a computer-related entity, either hardware, a combination of software and tangible hardware, software, or software in execution. For example, a component can be, but is not limited to, tangible components such as a processor, chip memory, mass storage devices (e.g., optical drives, solid state drives, and/or magnetic storage media drives), and computers, and software components such as a process running on a processor, an object, an executable, a data structure (stored in volatile or non-volatile storage media), a module, a thread of execution, and/or a program.

By way of illustration, both an application running on a server and the server can be a component. One or more components can reside within a process and/or thread of execution, and a component can be localized on one computer and/or distributed between two or more computers. The word “exemplary” may be used herein to mean serving as an example, instance, or illustration. Any aspect or design described herein as “exemplary” is not necessarily to be construed as preferred or advantageous over other aspects or designs.

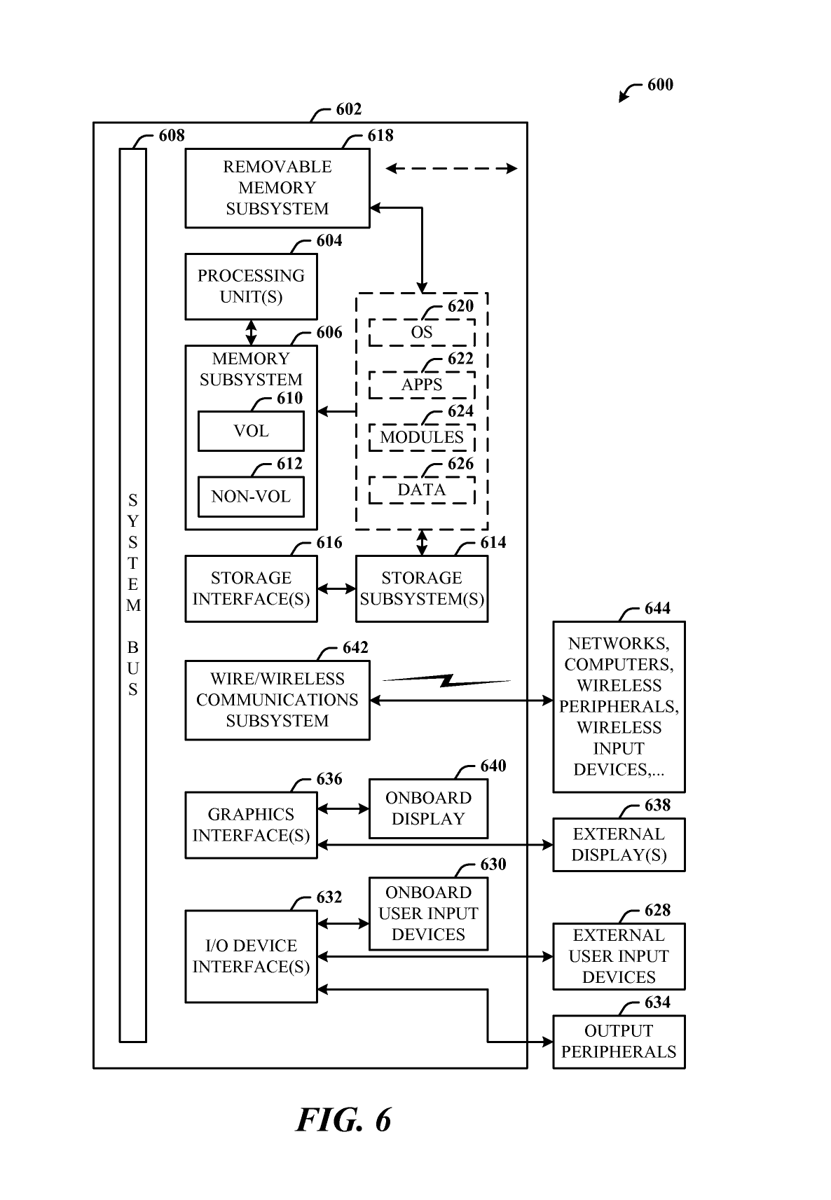

Referring now to FIG. 6, there is illustrated a block diagram of a computing system 600 that maps topic summaries to search results in accordance with the disclosed architecture. However, it is appreciated that the some or all aspects of the disclosed methods and/or systems can be implemented as a system-on-a-chip, where analog, digital, mixed signals, and other functions are fabricated on a single chip substrate.

In order to provide additional context for various aspects thereof, FIG. 6 and the following description are intended to provide a brief, general description of the suitable computing system 600 in which the various aspects can be implemented. While the description above is in the general context of computer-executable instructions that can run on one or more computers, those skilled in the art will recognize that a novel embodiment also can be implemented in combination with other program modules and/or as a combination of hardware and software.

The computing system 600 for implementing various aspects includes the computer 602 having processing unit(s) 604 (also referred to as microprocessor(s) and processor(s)), a computer-readable storage such as a system memory 606, and a system bus 608. The processing unit(s) 604 can be any of various commercially available processors such as single-processor, multi-processor, single-core units and multi-core units. Moreover, those skilled in the art will appreciate that the novel methods can be practiced with other computer system configurations, including minicomputers, mainframe computers, as well as personal computers (e.g., desktop, laptop, tablet PC, etc.), hand-held computing devices, microprocessor-based or programmable consumer electronics, and the like, each of which can be operatively coupled to one or more associated devices.

The computer 602 can be one of several computers employed in a datacenter and/or computing resources (hardware and/or software) in support of cloud computing services for portable and/or mobile computing systems such as cellular telephones and other mobile-capable devices. Cloud computing services, include, but are not limited to, infrastructure as a service, platform as a service, software as a service, storage as a service, desktop as a service, data as a service, security as a service, and APIs (application program interfaces) as a service, for example.

The system memory 606 can include computer-readable storage (physical storage media) such as a volatile (VOL) memory 610 (e.g., random access memory (RAM)) and non-volatile memory (NON-VOL) 612 (e.g., ROM, EPROM, EEPROM, etc.). A basic input/output system (BIOS) can be stored in the non-volatile memory 612, and includes the basic routines that facilitate the communication of data and signals between components within the computer 602, such as during startup. The volatile memory 610 can also include a high-speed RAM such as static RAM for caching data.

The system bus 608 provides an interface for system components including, but not limited to, the system memory 606 to the processing unit(s) 604. The system bus 608 can be any of several types of bus structure that can further interconnect to a memory bus (with or without a memory controller), and a peripheral bus (e.g., PCI, PCIe, AGP, LPC, etc.), using any of a variety of commercially available bus architectures.

The computer 602 further includes machine readable storage subsystem(s) 614 and storage interface(s) 616 for interfacing the storage subsystem(s) 614 to the system bus 608 and other desired computer components. The storage subsystem(s) 614 (physical storage media) can include one or more of a hard disk drive (HDD), a magnetic floppy disk drive (FDD), solid state drive (SSD), and/or optical disk storage drive (e.g., a CD-ROM drive DVD drive), for example. The storage interface(s) 616 can include interface technologies such as EIDE, ATA, SATA, and IEEE 1394, for example.

One or more programs and data can be stored in the memory subsystem 606, a machine readable and removable memory subsystem 618 (e.g., flash drive form factor technology), and/or the storage subsystem(s) 614 (e.g., optical, magnetic, solid state), including an operating system 620, one or more application programs 622, other program modules 624, and program data 626.

The operating system 620, one or more application programs 622, other program modules 624, and/or program data 626 can include entities and components of the system 100 of FIG. 1, entities and components of the system 200 of FIG. 2, entities and flow of the system 300 of FIG. 3, and the methods represented by the flowcharts of FIGS. 4 and 5, for example.

Generally, programs include routines, methods, data structures, other software components, etc., that perform particular tasks or implement particular abstract data types. All or portions of the operating system 620, applications 622, modules 624, and/or data 626 can also be cached in memory such as the volatile memory 610, for example. It is to be appreciated that the disclosed architecture can be implemented with various commercially available operating systems or combinations of operating systems (e.g., as virtual machines).

The storage subsystem(s) 614 and memory subsystems (606 and 618) serve as computer readable media for volatile and non-volatile storage of data, data structures, computer-executable instructions, and so forth. Such instructions, when executed by a computer or other machine, can cause the computer or other machine to perform one or more acts of a method. The instructions to perform the acts can be stored on one medium, or could be stored across multiple media, so that the instructions appear collectively on the one or more computer-readable storage media, regardless of whether all of the instructions are on the same media.

Computer readable media can be any available media that does not employ propagated signals, can be accessed by the computer 602, and includes volatile and non-volatile internal and/or external media that is removable or non-removable. For the computer 602, the media accommodate the storage of data in any suitable digital format. It should be appreciated by those skilled in the art that other types of computer readable media can be employed such as zip drives, magnetic tape, flash memory cards, flash drives, cartridges, and the like, for storing computer executable instructions for performing the novel methods of the disclosed architecture.

A user can interact with the computer 602, programs, and data using external user input devices 628 such as a keyboard and a mouse, as well as by voice commands facilitated by speech recognition. Other external user input devices 628 can include a microphone, an IR (infrared) remote control, a joystick, a game pad, camera recognition systems, a stylus pen, touch screen, gesture systems (e.g., eye movement, head movement, etc.), and/or the like. The user can interact with the computer 602, programs, and data using onboard user input devices 630 such a touchpad, microphone, keyboard, etc., where the computer 602 is a portable computer, for example.

These and other input devices are connected to the processing unit(s) 604 through input/output (I/O) device interface(s) 632 via the system bus 608, but can be connected by other interfaces such as a parallel port, IEEE 1394 serial port, a game port, a USB port, an IR interface, short-range wireless (e.g., Bluetooth) and other personal area network (PAN) technologies, etc. The I/O device interface(s) 632 also facilitate the use of output peripherals 634 such as printers, audio devices, camera devices, and so on, such as a sound card and/or onboard audio processing capability.

One or more graphics interface(s) 636 (also commonly referred to as a graphics processing unit (GPU)) provide graphics and video signals between the computer 602 and external display(s) 638 (e.g., LCD, plasma) and/or onboard displays 640 (e.g., for portable computer). The graphics interface(s) 636 can also be manufactured as part of the computer system board.

The computer 602 can operate in a networked environment (e.g., IP-based) using logical connections via a wired/wireless communications subsystem 642 to one or more networks and/or other computers. The other computers can include workstations, servers, routers, personal computers, microprocessor-based entertainment appliances, peer devices or other common network nodes, and typically include many or all of the elements described relative to the computer 602. The logical connections can include wired/wireless connectivity to a local area network (LAN), a wide area network (WAN), hotspot, and so on. LAN and WAN networking environments are commonplace in offices and companies and facilitate enterprise-wide computer networks, such as intranets, all of which may connect to a global communications network such as the Internet.

When used in a networking environment the computer 602 connects to the network via a wired/wireless communication subsystem 642 (e.g., a network interface adapter, onboard transceiver subsystem, etc.) to communicate with wired/wireless networks, wired/wireless printers, wired/wireless input devices 644, and so on. The computer 602 can include a modem or other means for establishing communications over the network. In a networked environment, programs and data relative to the computer 602 can be stored in the remote memory/storage device, as is associated with a distributed system. It will be appreciated that the network connections shown are exemplary and other means of establishing a communications link between the computers can be used.

The computer 602 is operable to communicate with wired/wireless devices or entities using the radio technologies such as the IEEE 802.xx family of standards, such as wireless devices operatively disposed in wireless communication (e.g., IEEE 802.11 over-the-air modulation techniques) with, for example, a printer, scanner, desktop and/or portable computer, personal digital assistant (PDA), communications satellite, any piece of equipment or location associated with a wirelessly detectable tag (e.g., a kiosk, news stand, restroom), and telephone. This includes at least Wi-Fi™ (used to certify the interoperability of wireless computer networking devices) for hotspots, WiMax, and Bluetooth™ wireless technologies. Thus, the communications can be a predefined structure as with a conventional network or simply an ad hoc communication between at least two devices. Wi-Fi networks use radio technologies called IEEE 802.11x (a, b, g, etc.) to provide secure, reliable, fast wireless connectivity. A Wi-Fi network can be used to connect computers to each other, to the Internet, and to wire networks (which use IEEE 802.3-related media and functions).

What has been described above includes examples of the disclosed architecture. It is, of course, not possible to describe every conceivable combination of components and/or methodologies, but one of ordinary skill in the art may recognize that many further combinations and permutations are possible. Accordingly, the novel architecture is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A system, comprising:
a mapping component that performs a mapping that facilitates presentation of a topic summary of a first data source in association with a search result related to a webpage of a second data source, the topic summary having a topic identifier that is mapped to a page identifier of the webpage, the topic summary fetched for display as part of the search result related to the second data source based on the page identifier; and
a microprocessor that executes computer-executable instructions associated with the mapping component.

2. The system of claim 1, wherein the topic identifier is inserted as metadata into an internal extended representation of the webpage.

3. The system of claim 1, wherein the topic identifier is mapped to multiple webpages.

4. The system of claim 1, wherein the webpage identifier is created.

5. The system of claim 1, wherein the webpage identifier is a predefined identifier that is obtained from the webpage.

6. The system of claim 1, further comprising a selection component that selects the topic summary for presentation as part of the search result.

7. The system of claim 1, further comprising a selection component that discriminates from a set of topic summaries which topic summaries to display and which topic summaries to not display as part of the search result.

8. The system of claim 7, wherein the selection component includes a classifier that selects the topic summaries using a selection model that is trained based on topic summaries tagged as for display or not for display.

9. The system of claim 8, wherein the topic summaries are classified using the classifier based on features related to text and media elements of the topic summaries.

10. A method performed by a computer system executing machine-readable instructions, the method comprising:
receiving multiple data sources having corresponding webpages, the webpages related to topic summaries that have topic identifiers;
mapping the topic identifiers to webpage identifiers of the webpages;
inserting the topic identifiers into respective internal extended representation of the webpages; and
retrieving the topic summaries from a first data source into search results related to the webpages of a second data source using the topic identifiers of the internal extended representations.

11. The method of claim 10, further comprising creating the webpage identifier based on information from the webpage or external information.

12. The method of claim 10, further comprising presenting a topic summary proximate a related search result.

13. The method of claim 10, further comprising classifying the topic summaries as to-be displayed or not-to-be displayed based on features related to text and media elements of the topic summaries.

14. The method of claim 10, further comprising mapping the topic summaries to multiple webpages.

15. The method of claim 10, further comprising serving the topic summary at runtime based on the inserted topic identifier of the internal extended representation.

16. A method performed by a computer system executing machine-readable instructions, the method comprising:
receiving multiple data sources of respective webpages, the data sources include a first data source having topic summaries mapped to corresponding topic identifiers;
deriving a webpage identifier for each of the webpages of a second data source;
associating a webpage identifier of a webpage of the second data source with a topic identifier of the first data source;
inserting the topic identifier into internal representation information of the webpage of the second data source; and
presenting the topic summary from the first data source as part of a search result associated with the webpage of the second data source based on the inserted topic identifier of the webpage.

17. The method of claim 16, further comprising classifying the topic summaries as to-be displayed or not-to-be displayed based on features related to text and media elements of the topic summaries.

18. The method of claim 16, further comprising presenting the topic summary as an interactive object proximate the search result.

19. The method of claim 16, further comprising deriving the webpage identifier by either creating the webpage identifier for the webpage or obtaining the webpage identifier from the webpage.

20. The method of claim 16, further comprising serving the topic summary at runtime based on the inserted topic identifier of the webpage.
